(19) United States
(12) Patent Application Publication
(10) Pub. No.: US 2007/0256037 A1
(43) Pub. Date: Nov. 1, 2007

(54) Net-list organization tools

(76) Inventors: Vyacheslav L. Zavadsky, Ottawa (CA); Edward Keyes, Ottawa (CA); Sergei Sourjko, Ottawa (CA); Val Gont, Kanata (CA); Stephen Begg, Ottawa (CA); Jason Abt, Kanata (CA)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/411,593

(22) Filed: Apr. 26, 2006

(51) Int. Cl. G06F 17/50

(52) U.S. Cl. 716/2; 716/3

(57) ABSTRACT

The present invention provides an accurate and efficient method of organizing circuitry from a net-list of an integrated circuit, by the steps of generating a reference pattern; identifying the potential matches in the net-list using inexact graph matching; further analyzing the matches to determine if they match the reference pattern; and organizing the net-list into a hierarchy by replacing the identified instances with higher-level representations.

### FIELD OF INVENTION

This invention relates to a method of design analysis of existing integrated circuits, and more particularly to the determination of repetitive sub-circuits from a net-list of a reverse-engineered integrated circuit.

### BACKGROUND OF THE INVENTION

In the intensely competitive field of microelectronics, detailed analysis of a semiconductor integrated circuit product can provide valuable information as to how a particular technical problem was dealt with, overall strengths and weaknesses of a design approach, and the like. This information can be used to make decisions regarding market positioning, future designs and new product development. As well, it can be key evidence in cases of patent infringement and/or licensing. The information resulting from analysis of the product is typically provided through circuit extraction (reverse engineering), functional analysis and other technical means. At the core of this activity is the process of design analysis, which, in this context, refers to the techniques and methodology of deriving complete or partial schematics, starting with any type of integrated circuit in any process technology. For such technical information to be of strategic value, it must be accurate and cost-effective, and the information should be obtained in a timely fashion.

There are many software applications in existence that can provide design analysis, but most are geared towards integrated circuit (IC) testing and verification at the design and fabrication end as opposed to the design analysis or reverse engineering end. Before a new IC design is released on the market, it must undergo tests to ensure that it is functional and working according to its specifications. The testing can happen in one of two stages of the IC production process: testing of the finished product and testing of the design layout. The design layout is the mask, which is used to produce the physical IC from a schematic design of electrical components. This layout is typically created using a software application. In both stages of testing, the finished IC or the design layout is compared to a reference. Having a reference leaves little room for errors or ambiguity.

A design analysis or reverse engineering process typically does not have a detailed reference to follow so errors are more prone to occur. Heretofore, a design analysis process typically involved manually extracting circuit information from a set of large “photomosaics” of an integrated circuit. Photomosaics are high magnification photographs of portions of an IC mosaicked or stitched together. An IC is a die contained within a material such as plastic or ceramic packaging. A die is a plurality of metal and polysilicon layers electrically connected together. The polysilicon (poly) layer(s) define the electrical components such as the transistors, resistors and capacitors, and the metal layers electrically connected above the poly layer(s) define the connections between the electrical components. To properly extract the circuitry, photomosaics of each and every connectivity (i.e. poly and metal) layer are required.

Due to advances in image processing and electron microscopy, traditional photomosaics have largely been replaced with computer workstations. Topographical images of the poly and metal layers can be viewed on a computer through dedicated software. U.S. Pat. No. 6,907,583 by Abt et al. describes such software, and is incorporated herein by reference. The dedicated software depicts the IC layout as a series of polygons representing the arrangement of the various metal layers. Each metal layer is shown as a different color to differentiate between one another. The layers can be selected and de-selected so the specialist can view selected layers instead of all of them. Although this technique is less time-consuming than the use of traditional photomosaics, the specialist must still manually extract all the circuitry (a process known as circuit readback). What is especially time-consuming is the extraction and organization of repetitive blocks of electrical components, commonly known as standard cells. Standard cells can make up a large part of an IC, yet the specialist must manually extract each standard cell individually.

Co-pending US Published Application 20060045325, filed Aug. 31, 2004 entitled “Method of Design Analysis of Existing Integrated Circuits”, incorporated herein by reference, describes an automated process of identifying repetitive circuitry from the layout image. While this method is more time efficient than the manual method, it assumes that each sub-circuit has the same layout, which is not always the case. Advances in IC design and the pursuit of smaller ICs have meant that circuit blocks are now often spread over the entire area of the die in an effort to efficiently use the available space. Most IC design is now automated so that the software programs will automatically place the electrical components in a space efficient manner, which may not necessarily be in a logical or visually appealing manner. This automated process is called auto-routing. Nevertheless, even though the circuit block is not visually identical, it is likely electrically identical in that it has correspondingly similar electrical connections. For example, circuit elements belonging to the same functional block may be placed at opposite ends of a die. In the case of auto-routed layouts, it is difficult to identify repetitive circuitry by relying on them having the same layout, because the layouts will likely be different.

There is a need, therefore, for pattern-matching techniques that can identify groups of transistors or gates based on their electrical connections, rather than on their physical layouts.

A net-list is a list of electrical components of a circuit and their interconnections. Each interconnection or “net” is assigned a unique label. The net-list will list each component as well as every net to which each of the terminals of each component is connected. Thus, even though each instance of repetitive circuitry in a layout can be physically different, its sub-net-lists (that portion of the net-list describing an instance of the repetitive circuitry) should be similar to other instances of the repetitive circuitry.

Isomorphism is defined as having the “same form” or “same shape”. If two groups of elements are isomorphic, there is a one-to-one relationship between the elements of one group and the elements of another. Graph isomorphism signifies that two entire graphs are identical. Sub-graph isomorphism implies that there is a one-to-one relationship between each element of a sub-graph of one larger graph and the corresponding sub-graph of another larger graph.

Sub-graph isomorphism is an example of a pattern-matching technique that may be used advantageously in the present invention. Applied to a transistor or gate level net-list, one could expect that the net-list of every instance of a pattern, consisting of a plurality of transistors or gates, could be found in a larger transistor or gate level net-list. That is, the net-list pattern could be represented as a sub-graph, while the larger transistor or gate level net-list could be modeled as a graph.

In the field of circuit design analysis and verification, it is known that sub-graph isomorphism assumes that all the transistors and electrical net connections present in a sub-graph could be found in a larger circuit graph. This identification of sub-circuits in a larger transistor-level circuit design is sometimes referred to as sub-circuit extraction.

In the known art, there are two types of pattern matching for which sub-graph isomorphism could be used, inexact or exact pattern matching.

In exact pattern-matching, a pattern instance in the circuit design will only be identified as such if it precisely matches the specification of the pattern. If any modification exists, a pattern matcher will not recognize the instance. For example, the pattern matcher will miss a pattern instance if inputs are attached to Vdd or GND, or if inputs are shorted together.

In inexact pattern-matching, on the other hand, an instance will be recognized even if certain modifications are made, while embedding the pattern in the larger transistor-level net-list, such as common modifications made by circuit designers. Examples include attaching inputs to Vdd or GND and shorting together of inputs, all of which are common modifications. Only an inexact pattern matcher will be able to identify such pattern instantiations.

To achieve such inexact pattern-matching, the constraints for isomorphism are relaxed at the pattern's external (boundary) net connections such that external nets in the pattern instance can be connected to special nets, such as Vdd or GND, or shorted to other external nets. Inexact sub-graph isomorphism proves especially useful in transistor pattern-matching because, heretofore, users were required to specify a potentially exponential number of exact patterns in order to find all possible combinations of external connectivity, all of which is obviated in inexact sub-graph isomorphism.

An example of exact pattern matching using sub-graph isomorphism is discussed by M. Ohlrich, C. Ebeling, et. al. at the University of Washington, in an article entitled “SubGemini: Identifying Sub-circuits using a Fast Subgraph Isomorphism Algorithm”, 30th ACM/IEEE Design Automation Conference, 1993 IEEE, pp. 31-37. The authors describe a solution to the exact sub-graph isomorphism problem for transistor-level net-lists, a sub-circuit extraction technique entitled SubGemini, which is an extension of the graph isomorphism approach developed by Corneil in his Ph.D. thesis, Corneil, D. G. “Graph Isomorphism. Ph.D. thesis”, University of Toronto, Toronto, Ontario, Canada, 1968. In Ohlrich et al., the pattern and the main circuit design (master graph) are labeled alternately. Labels are based on matched neighbors. Thus, if two nets or two devices have the same label, a match is possible. Unfortunately, it is not possible to extend the Olrich et al. algorithm to compare labels for anything other than equality, and there is no method for matching two pattern nets to one master net, as is the case when the inputs are shorted together. Further, it is not possible for a pattern net to be matched to a master Vdd or GND net, since these must be provided with special labels in order to be identified as Vdd or GND. Therefore, SubGemini can perform only exact sub-graph pattern matching, and does not solve the inexact sub-graph isomorphism problem.

There are some algorithms for inexact graph matching that are well known in the art and are widely used, for example, in the field of bioinformatics. Algorithms for inexact graph matching are disclosed in Messmer B., Bunke H., “A network based approach to exact and inexact graph matching”, Technical Report IAM-93-021, University of Bern, Institut für Informatik und angewandte Mathematik, 1993; and Hlaoui A., Wang S., “A New Algorithm for Inexact Graph Matching”, 16^{th} International Conference on Pattern Recognition (ICPR'02) Volume 4, 2002. U.S. Pat. No. 6,473,881 also discloses an inexact graph matching technique.

The aforementioned inexact graph matching techniques do not, however, address the particular issues that arise in reverse engineering. Rather, they deal with recognition of patterns in the context of IC verification, in which the objective is to compare the actual integrated circuit against a reference schematic to identify errors.

In reverse engineering, as indicated previously, there is no reference schematic to compare against, as is the case in IC verification. Also, errors sometimes occur during the reverse engineering process itself, such as errors in the image layout or misidentified gates or transistors during circuit readback, which are unknown in the IC verification process. As well, some sub-circuits may have the same functionality, but appear structurally different. This is especially true of complex gates, which may have multiple representations of the same electrical connectivity. Inexact graph matching techniques for reverse engineering purposes must be sufficiently robust not only to consider errors in the derived net-list, but also to handle sub-circuits which may be structurally different yet have the same functionality, and be able to do so without the benefit of a reference schematic.

There is a need, therefore, for a technique that helps to organize a circuit net-list into a logical manner, by automatically identifying repetitive circuitry, as well as addressing and compensating for the aforementioned errors that can arise during the reverse engineering process.

### SUMMARY OF THE INVENTION

The present invention is directed to optimizing the organization of a net-list of an extracted IC.

The present invention describes a toolkit that organizes a net-list into a logical hierarchy by automatically identifying repetitive circuitry blocks using an inexact sub-graph isomorphism technique. This invention isolates functionally identical circuitry that may have different layouts and different structures.

First, the net-list is extracted using known techniques. One of the advantages of the present invention is to automatically identify repetitive circuit blocks or standard cells.

In a preferred embodiment of the invention, reference pattern generation to define a starting standard cell or reference circuit pattern is accomplished by selecting a component or gate, group of components or a signal of interest and performing a proximity query thereon. Analysis of the query results follows and the proximity query is repeated until an initial reference circuit pattern is derived.

An alternative embodiment of the present invention uses structural data mining techniques after the net-list is extracted to perform the higher order filtration and find the highest-order repetitive sub-circuits. Structural data-mining searches for highest-order sub-circuits based strictly on the net-list. The functionality of the resultant repetitive sub-circuits is analyzed and reference circuit patterns are derived therefrom.

In either embodiment, inexact graph matching is then executed upon the net-list to identify repetitive instances of the reference circuit pattern obtained by the higher order filtration including instances that the higher-order filtration techniques may have missed due to imaging or circuit extraction errors. Custom rules are used to account for imaging errors and structural differences within the repetitive circuits. Using these repetitive instances, top-down hierarchies are built. The process repeats until the entire extracted net-list is organized into a logical hierarchy.

In accordance with a first broad aspect of the present invention, there is disclosed a method of organizing circuitry from a net-list of an integrated circuit into a hierarchy, comprising the steps of:
a. generating a reference pattern;
b. identifying repetitive instances of said reference pattern in said net-list, using inexact graph matching;
c. creating a hierarchy within the net-list based on the identified repetitive instances; and
d. repeating steps a. through c. until the net-list has been organized into a hierarchy.

In accordance with a second broad aspect of the present invention, there is disclosed an apparatus adapted to organize circuitry from an existing IC layout into a hierarchy comprising:
a. a net-list data store adapted to maintain a net-list of the circuitry;
b. a pattern generator adapted to identify reference circuit patterns from the net-list;
c. a search engine adapted to find repetitive instances of the reference circuit patterns in the net-list; and
d. a hierarchy generator adapted to organize the net-list into a hierarchy based on the repetitive instances.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a flowchart of the processing performed in accordance with a preferred embodiment of the present invention;

FIG. 2a is a schematic representation and a net-list representation of an exemplary XOR gate for illustrating the operation of the present invention;

FIG. 2b is a schematic representation and a net-list representation of a second electrically equivalent exemplary XOR gate for illustrating the operation of the present invention;

FIG. 2c is a schematic representation and a net-list representation of an exemplary potential XOR for illustrating the operation of the present invention;

FIG. 2d is a higher-level schematic representation and a net-list representation of an exemplary XOR for illustrating the operation of the present invention;

FIG. 3a is a schematic representation of an exemplary inverter for illustrating the operation of the present invention [ml];

FIG. 3b is a schematic representation of the inverter of FIG. 3a within exemplary circuitry disclosed by a forward first level proximity query;

FIG. 3c is a schematic representation of the inverter of FIG. 3a within exemplary circuitry disclosed by a forward second level proximity query;

FIG. 4 is a flowchart of the processing performed in accordance with an inexact graph matching technique enabled by the present invention;

FIG. 5 is a schematic representation of an exemplary reference circuit pattern;

FIG. 6 is a graphical representation of the reference circuit pattern of FIG. 5;

FIG. 7 is a graphical representation of a first level alternative hashing diagram of the graphical representation of FIG. 6;

FIG. 8 is a graphical representation of a second level alternative hashing diagram of the graphical representation of FIG. 6; and

FIG. 9 is a block diagram of an exemplary apparatus for use in conjunction with the present invention.

### DETAILED DESCRIPTION

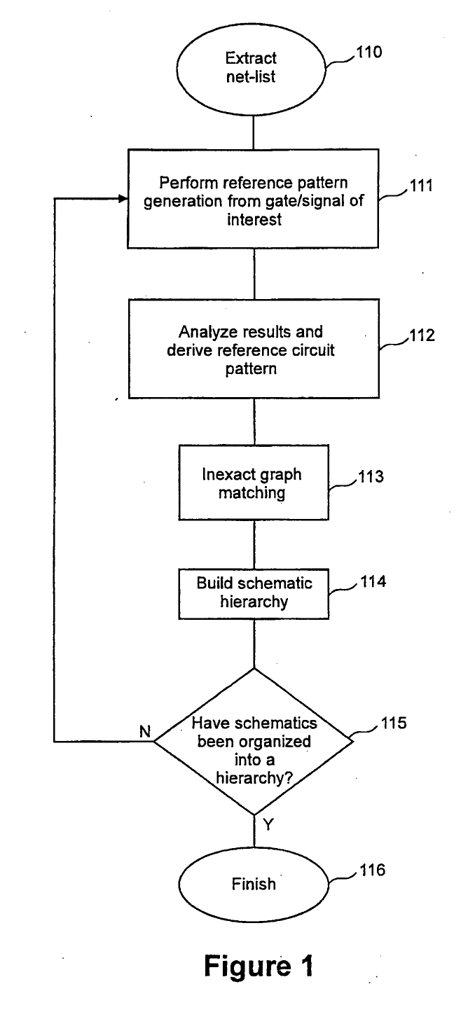

The present invention provides a fast and efficient method of recognizing sub-circuits within an integrated circuit (IC) net-list, in order to create a hierarchical representation of the net-list. FIG. 1 shows an overview of the method of the present invention in flow chart form.

The first part of the method is to develop a gate-level net-list 110, which can be done by means of signal tracing and circuit readback. It is not necessary to extract the entire circuitry of the IC to generate a net-list. The present invention works on a net-list of a portion of a circuit as well. Once the net-list has been obtained, the process of organizing its entries into a hierarchy begins. The hierarchy is created by examining the repetitive instances of entries in the net-list and identifying individual entries or combinations thereof as sub-circuits.

This can aid in the simplified display of the schematic representation of the net-list entries.

Sub-circuits are identified by means of reference pattern generation 111, such as a proximity query, or structural data mining.

Reference pattern generation 111 can be performed on a particular signal, gate or component subset. The result of the reference pattern generation 111 is analyzed 112, and adjusted until it is recognized as forming part of a higher order functional block, such as a more complex component. Persons of ordinary skill in the art will readily identify those mechanisms by which higher order functional blocks can be recognized. This recognized functional block is denoted as a reference circuit pattern. Multiple iterations of increasing scope may be required before a functional block can be identified.

Armed with the reference circuit pattern, thus obtained, inexact graph matching is performed 113 to find all the instances of the reference circuit pattern in a circuit from the net-list data. Inexact graph matching can account for errors in the extracted net-list, which were due to errors during imaging of the IC layout or the circuit extraction process.

Because the reference circuit pattern may have been physically laid out differently in some instances, the net-list representation of another instance of the same reference circuit pattern may not be identical to that of the identified reference circuit pattern. Inexact graph matching can account for such differences whether due to the layout or the structure of the higher order component itself.

There may be project specific rules that are accommodated within the inexact graph matching 113. For example, in circuit design, chains of inverters may be used to implement delay times. For purposes of reverse engineering, such timing relationships may sometimes be ignored. In such cases, all that is of interest from a logic perspective is whether the result is or is not inverted. Thus, a project-specific rule may be implemented to replace all chains of inverters with either a single inverter or a pair of inverters. User-defined functions therefore can be used to accommodate such project-specific rules.

After the application of inexact graph matching 113, a higher order representation of the circuit schematic is created 114 using the identified instances of the reference circuit pattern(s). A hierarchy can be created by defining the reference circuit pattern in a lower level schematic and showing a higher level schematic with the defined reference circuit pattern in place of the components comprising it. This hierarchy can also be created in the net-list, by creating higher order representation net-list entries.

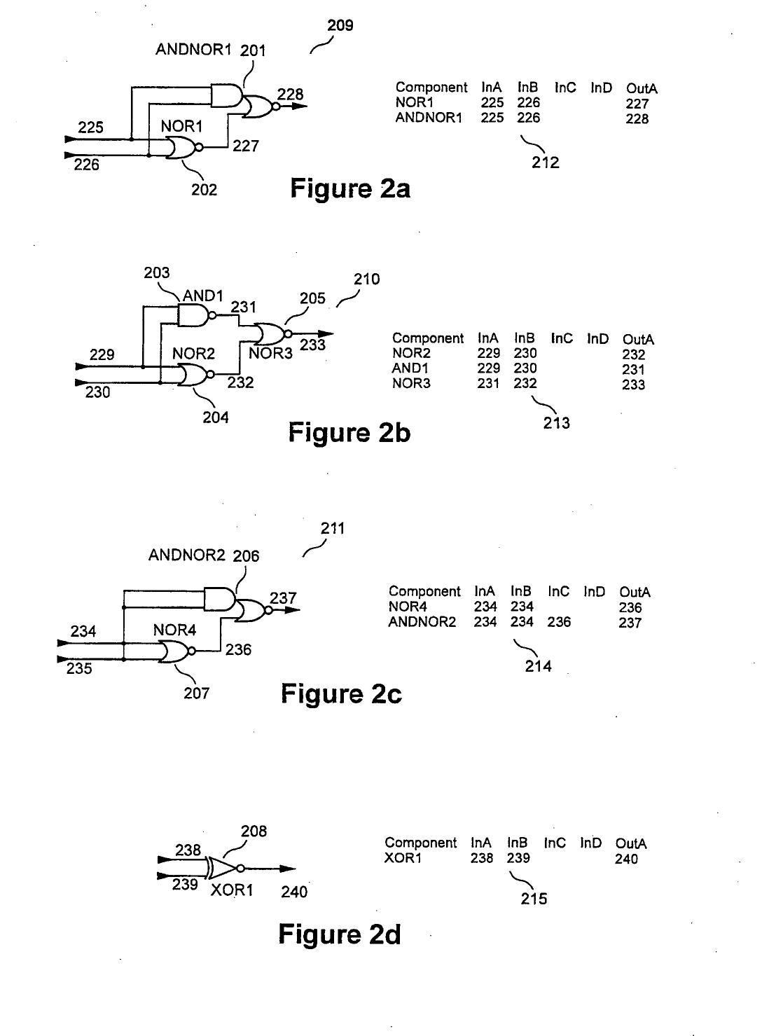

The creation of a higher-level schematic representation is accomplished through the replacement of low-level schematics showing detailed connections between gates with higher-level blocks that simplify repetitive logic or circuits. In FIG. 2a, a schematic representation of an XOR gate is shown, comprised of a NOR gate 202 connected to an ANDNOR gate 201 to provide the functionality of an exclusive OR. The net-list 212 for this circuit element is shown beside the figure. In FIG. 2d, a higher-level schematic representation of an XOR gate 208 is shown, along with the revised net-list.

After the higher-level schematic is created 114, it can be determined if the higher-level schematic has been sufficiently organized into a hierarchy 115. If it has, the process is finished 116. If the higher level schematic still requires organization, the process returns to the extracted net-list and performs reference pattern generation on a new signal, gate, or component sub-set of interest 111 to create a new reference circuit pattern. The process then continues to iterate until the schematics have been sufficiently organized into a hierarchy. The obtaining of a gate level net-list 110 can be accomplished in a variety of fashions. An interactive circuit extraction approach, disclosed in U.S. Published Patent Application 20030084409 assigned to Semiconductor Insights Inc. entitled “Computer aided method of circuit extraction” and incorporated by reference herein, is one method. Another involves obtaining a transistor level net-list from a de-layered IC, and applying functional abstraction methods such as disclosed in the following publications: M. Boehner, “LOGEX—an automatic logic extractor from transistor to gate level for CMOS technology”, Proceedings of the 25th ACM/IEEE conference on Design automation (1988) 517-522 and R.E. Bryant “Extraction of Gate Level Models from Transistor Circuits by Four-Valued Symbolic Analysis” International Conference on Computer-Aided Design (1991). Still further, one could obtain a gate level net-list from an interactive template matching process, such as described in previously referenced co-pending application “Method of design analysis of existing integrated circuits”. Those having skill in the art will readily recognize the possibility of other methods of obtaining a gate level net-list.

Reference pattern generation 111 can be accomplished using a variety of techniques known to a person skilled in the art. Two such techniques are known as proximity query, and structural data mining.

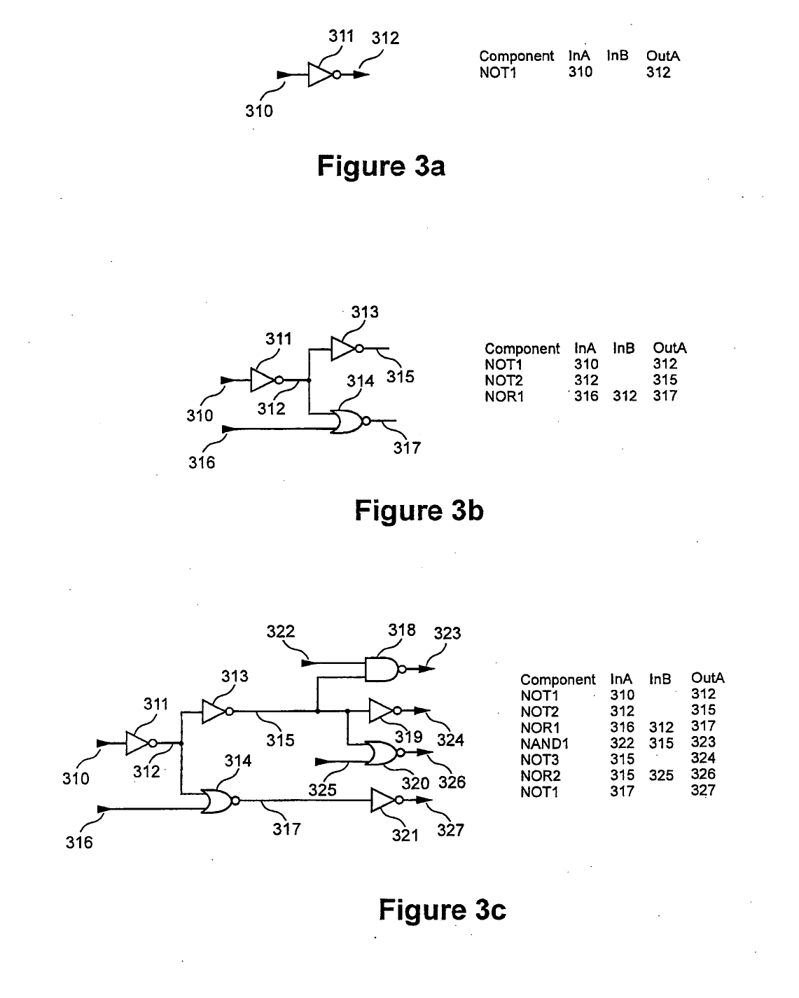

A proximity query will determine signal connections for a given input and/or output. The query accepts input as to the desired number of levels, either forward or backward, and a signal of interest. The query will then search along the path of the signal of interest and return the number of connections that are found along that signal path in both the forward or backward direction for the specified number of levels. FIGS. 3b and 3c show examples of a proximity query on the inverter 311 shown in FIG. 3a. Inverter 311 has a signal 310 at its input and signal 312 at its output. In a forward first level proximity query, as shown in FIG. 3b, the query returns all circuit elements that have signal 312 as an input. As shown in the present example, inverter 313 has signal 312 at its input and output signal 315 and NOR gate 314 has signal 312 and signal 316 as its inputs and outputs signal 317. The net-list provided by this query would consist of inverter 311, inverter 313 and NOR gate 314.

In a forward second level proximity query of signal 312, as shown in FIG. 3c, the query would return a net-list comprising not only inverter 311, 313 and NOR gate 314, but also NAND gate 318, inverter 319, NOR gate 320 and inverter 321, because in the example circuit diagram these gates are all coupled to either signal 315 or signal 317, which are the outputs of inverter 313 and NOR gate 314. NAND gate 318 has signals 322 and 315 at its inputs and outputs signal 323. Inverter 319 has signal 315 at its input and outputs signal 324. NOR gate 320 has signal 315 and signal 325 at its inputs and outputs signal 326. Inverter 321 has signal 317 at its input and outputs signal 327. Similarly, a forward third level proximity query would return all gates having inputs coupled to signals 323, 324, 326 and 327.

Proximity queries can be performed by breadth-first search techniques, for example, that are well known in the art. Examples of such algorithms are found in Thomas H. Cormen et al. Introduction to Algorithms, MIT Press, 2001, Chapters 24-25. Other methods of performing a proximity query would be apparent to one skilled in the art.

Structural data mining looks for all repetitive structures in a graph. When applied to a net-list, it will look for repetitive sub-circuits that have a specified threshold number of gates, because the specified threshold is used to avoid multiple instances of structures having small numbers of gates. Because the preferred threshold number of gates can vary from project to project, it can be specified as a minimum number of gate connections, and repetitive instances of this defined number or more would be considered. Techniques to perform structural data mining are described in J. Gonzalez, I. Jonyer, L. B. Holder and D. J. Cook, “Efficient Mining of Graph-Based Data”, AAAI Workshop on Learning Statistical Models from Relational Data, 2000 and in Michihiro Kuramochi M. and George Karypis G. “Finding Frequent Patterns in a Large Sparse Graph”, University of Minnesota, Technical Report #03-039. Those having ordinary skill in the art will readily recognize the possibility of other methods of structural data mining.

Structural data mining involves a search for any repetitive structures in a net-list. Since this technique will search for any and all repetitive structures, the functionality of each of the repetitive patterns needs to be analyzed 112 until a functional block is derived. Unlike the proximity query, the structural data mining does not take into account errors within the net-list due to an incorrect extraction or errors in the IC image layout. However this can be addressed by the inexact graph matching step 113.

Inexact graph-matching 113 is to find all instances of the reference circuit pattern from the net-list of extracted circuitry. It identifies the sub-circuits that both exactly match the reference pattern, and those that match the pattern inexactly. For example if the selected reference circuit pattern is an ANDNOR gate, inexact graph-matching would locate all of the exact ANDNOR gates in the net-list and, in addition, would identify the inexact match of an individual AND gate connected to a NOR gate in such a manner that it would perform the same function as an ANDNOR gate.

With reference to the collective FIG. 2, inexact graph matching would identify all the instances of the exemplary XOR gates shown in FIG. 2a, FIG. 2b and FIG. 2c as being similar. This would be accomplished by noting FIG. 2a as the reference pattern to be searched for.

FIG. 2a shows NOR gate 202 connected at its output to an ANDNOR gate 201, and furthermore sharing inputs 225 and 226, the resultant output 228 would be representative of the functionality of an XOR gate. As such, the simplified display of this component schematically and in the net-list would be that of an XOR gate 208 as shown in FIG. 2d.

FIG. 2b shows NOR gate 204 connected at its output to NOR gate 205. NOR gate 204 also shares its inputs 230 and 229 with an AND gate 203, which is then connected at its output to the other input of NOR gate 205. The resultant functionality of this circuit is again an XOR gate 208, and has been accomplished by replacing the ANDNOR gate 201 of FIG. 2a, with an AND gate 203 and a NOR gate 205. Inexact graph matching would identify this as having a similar net-list to the reference pattern of FIG. 2a, and would then use the user defined functions to recognize the replacement of the ANDNOR gate 201.

FIG. 2c shows NOR gate 207 connected at its output to ANDNOR gate 206. NOR gate 207 also shares its inputs 234 and 235 with two inputs to the ANDNOR gate 206. However in this case there is an error, as the inputs 234 and 235 have been shorted together. The net-list will only record the first input, and thus the inputs would both be labeled as 234 in the adjacent net-list 214. Inexact graph matching would identify this as having a similar net-list to the reference pattern of FIG. 2a, and would then use error correction to identify the short circuit between inputs 234 and 235 and then replace it with the correct net using user defined functions.

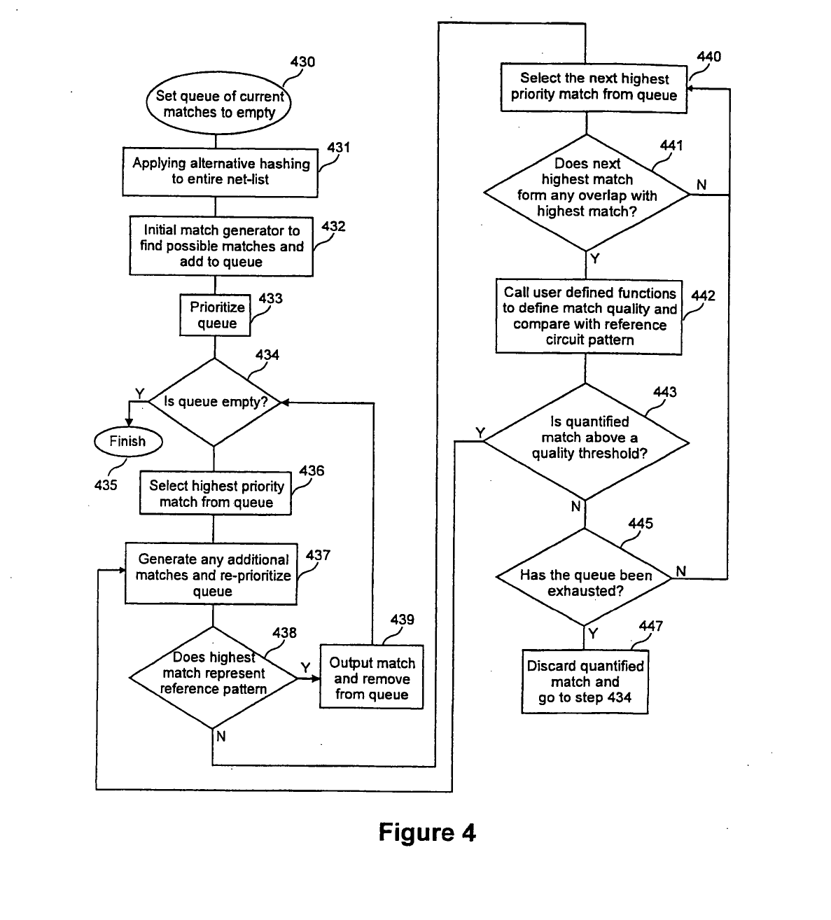

FIG. 4 is a flowchart of an inexact graph-matching process that can be used with the present invention. First, the queue of possible matches is initialized 430 to an empty value, such as zero.

Next, the entire net-list of extracted circuitry-including the reference sub-circuit is re-labeled using alternative hashing 431. This new labeling makes the identification of repetitive instances of the sub-circuit more efficient. The labels generated from each level of alternative hashing are stored in the queue. This queue is also known as a hash table.

The re-labeling using alternative hashing 431 helps to identify repetitive instances. A reference sub-circuit may contain a large number of components and matching the entire sub-circuit to the net-list is very intensive and requires a great amount of processing power and memory. In order to reduce this processing time, matches are initially made with subsets of the sub-circuit such as a single gate or a small combination of gates. Even so, this initial match results in a large queue of possible matches.

Thereafter, an initial list of matching subsets of the reference sub-circuit is created and added to the queue 432. This list is then prioritized 433 according to its suitability and ease of matching. This list is generally prioritized in terms of quality and quantity of connections that could possibly occur. For example, a match of a NOR gate connected to a NOR gate has a higher priority than a match of a NOR gate connected to a NAND gate, as it occurs less frequently in digital logic. Also, matching a single standard gate to the entire net-list will result in a sizable number of matches. Matching a non-standard gate, however, will likely result in a smaller number of matches. As a result, non-standard gates will have a higher priority than standard gates. Determination of which gates could be standard, and which could be non-standard will depend on the device being investigated, and is taken into account when determining prioritization.

When the queue is empty 434, the inexact graph matching step 113 is completed. Otherwise, the highest priority match is selected from the queue 436. Error correction and design rules are applied 437 to the circuitry surrounding the highest priority match and the queue is re-prioritized so that matches that seemed low on the list in step 433 may move up to create a revised list. Such error correction rules include correcting for image processing defects such as a break in a wire in the image layout. If the break is smaller than the allowable distance between two signal wires on a layout according to layout design rules, then this may indicate a possible error generated from the image capture of the IC. Other design rules include replacing a delay chain of an even number of components, such as an inverter, by a single wire or identifying pieces of combination logic as equivalent to known complex gates based on their truth tables. Step 437 also re-prioritizes the queue.

If the highest priority match represents the reference pattern, it is noted as a match to the reference pattern and is removed from the queue of possible matches 439. The next highest priority match in the queue now becomes the highest match and the process starts again.

If the highest priority match does not represent the reference pattern, the process must be analyzed further. The next highest priority match is selected from the queue 440. From this point forward, the process attempts to “grow” the highest match until it can match the reference pattern. The process of growing involves comparing the adjacent structures to the highest match to determine if they are similar to structures in the reference pattern. Adjacent structures are those that share the same inputs and/or outputs as the highest priority match. These adjacent structures are also said to “overlap” the highest priority match. The two matches are then compared to determine if any overlap exists between the two. This overlap could consist of a shared component, signal or gate. The next highest priority match is retrieved from the queue until the queue has been completely reviewed, or an overlap is identified 441. If the matches do form an overlap, the two matches are then combined into a single sub-circuit net-list, described hereinafter as an enlarged match. The output of this step can be an enlarged match, or the unchanged highest priority match.

This output is then revised using user defined functions, and quantified to qualify the match 442. Such functions are usually project specific, but also include logic equivalences and the like. An example of such a function is a component size limiter. It may be decided that a possible match should be discarded because the component sizes are not the same as the reference pattern even though the structure is the same. Another example, of such a function would be the equivalence of a NOR gate to a NAND gate with both inputs inverted.

This quantified match is then compared with the reference circuit pattern to determine if it is above a predefined quality threshold 443. This threshold is based on the number of differences between the two circuits. This threshold is usually set in advance, but it is possible that the threshold be set at the time of application of the method as well. If the enlarged match is above the quality threshold, this is a strong indication that it may be a match to the reference circuit. If the quantified match is at or above the threshold, it is added back to the top of the queue and the process returns to step 437. Otherwise, it is determined if all the matches in the queue that could potentially overlap with the quantified match have been exhausted 445. If they have not all been exhausted, the next highest priority match is selected for the queue 440. Otherwise, the process discards the quantified match 447 and selects a new highest priority match 434.

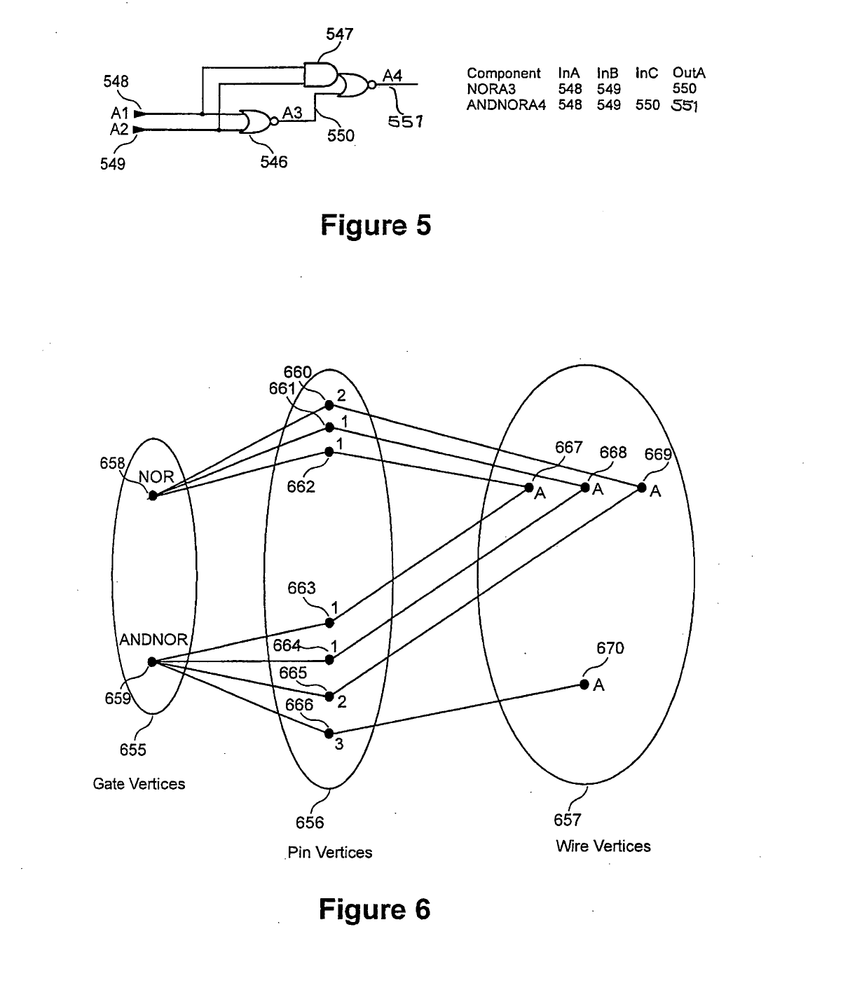

The process of inexact graph matching may be implemented using an alternative hashing technique to develop a list of possible matches to subsets of the reference sub-circuit in step 431. M. Ohlrich et al. first developed alternative hashing as part of the SubGemini project (alternative hashing is sometimes referred to as local feature invariance). It is a labeling technique that identifies each element based on their location to adjacent elements. Further explanation of the alternative hashing technique is explained using FIGS. 5 to 8, which methodically shows each step of the process. While these figures show a specific alternative hashing technique, the present invention should not be considered to be limited to this technique, as those having ordinary skill in the art will readily recognize that other alternative hashing techniques could be used.

FIG. 5 shows an example of a reference circuit pattern made up of a NOR gate 546 and an ANDNOR gate 547. In this circuit, there exist four wires, namely Al 548, A2 549, A3 550 and A4 551. Wires Al 548 and A2 549 are inputs to both NOR gate 546 and ANDNOR gate 547. Wire A3 550 is attached to both the output of NOR gate 546 and the remaining input of ANDNOR 547. Wire A4 551 is attached to the output of ANDNOR gate 547 only.

FIG. 6 is a graph representing the circuit of FIG. 5, showing the components of the schematic diagram of FIG. 5 but illustrating each point as its own vertex. This is a preliminary step to the alternative hashing that will be required. It organizes the schematic information into its component parts so that the creation of an alternative hashing is somewhat simplified and explained. This graph is divided into three groups of vertices: gate vertices 655, pin vertices 656 and wire vertices 657.

Gate vertices 655 describe the gates that are within the reference sub-circuit. In the example of FIG. 6, there exists NOR vertex 658 representing NOR gate 546 and ANDNOR vertex 659 representing ANDNOR gate 547. Within the group of pin vertices 656, each unique pin of a gate is given a unique number. For example, NOR gate 546 has two unique pin types: two input pin vertices 661, 662 and an output vertex 660. Since the input pins of a NOR gate are interchangeable, in that they could be substituted for each other without changing the function of the NOR gate, both input pin vertices 661, 662 are given the number 1. The output vertex 660 of NOR gate 546 is given a unique number 2, as there is only one output to the NOR gate.

ANDNOR gate 547 has three inputs: two input pin vertices 663, 664 for the AND portion and one input pin vertex 665 for the NOR portion. Since the two input pin vertices 661, 662 of the AND portion are interchangeable, they are both given the number 1. Input pin vertex 665 is different from input vertices 661, 662 as it could not be substituted with either without changing the function of the ANDNOR gate 547, therefore it is assigned number 2. Output pin vertex 666 of ANDNOR gate 547 is assigned number 3. The wire vertices 667, 668, 669 and 670 represent each individual wire A1 548, A2 549, A3 550 and A4 551 respectively of the sub-circuit shown in FIG. 5.

In FIG. 6, the wire vertices 667, 668, 669 and 670 are all labeled A for simplicity, but they could be labeled with any unique label. Attributing each wire vertex with its signal puts an unnecessary limitation when searching for possible matches of a sub-circuit. Most, if not all of the matches, will have different inputs and outputs.

The graph of FIG. 6 maps the wire vertices 667, 668, 669 and 670 to the pin vertices to which they are connected. For example, output pin vertex 660 of NOR gate 546 is attached to wire A3 550. This wire is also attached to input pin vertex 665 of ANDNOR gate 547. Hence, the wire vertex 669, which represents wire A3 550, attaches to both output pin vertex 660 and input pin vertex 665. This mapping demonstrates how NOR gate 546 is coupled to ANDNOR gate 547. From this graph, one can create the sub-circuit shown in FIG. 5.

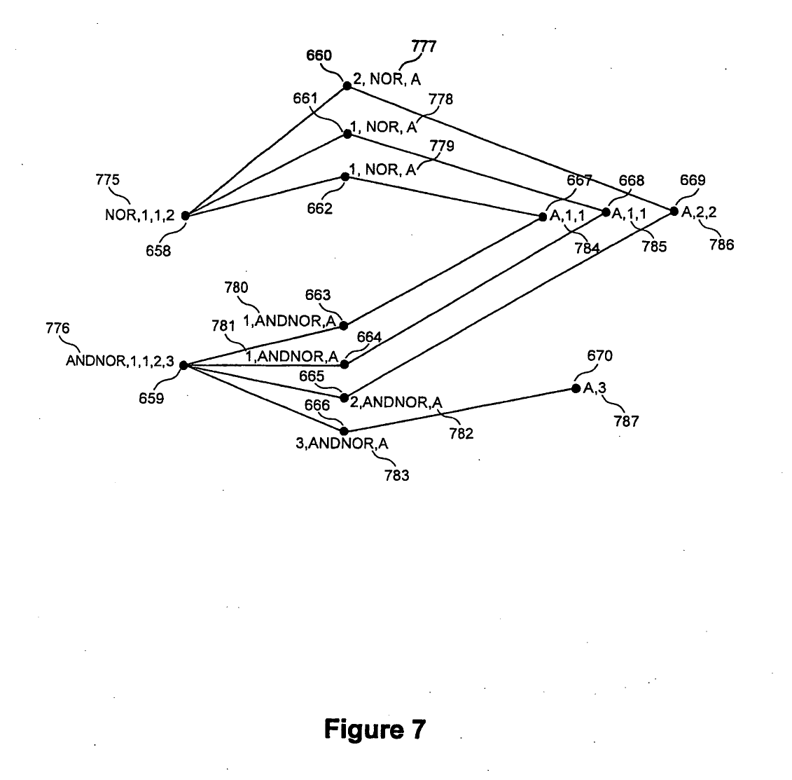

Using FIG. 6 as a base or zero level alternative hashing, a first level alternative hashing is shown in FIG. 7. In FIG. 6, the labels of each vertex are dependent on what type of vertex it is, such as gate, pin or wire. In FIG. 7, each vertex label contains information related to its adjacent vertices. The gate vertices 658 and 659 have respective labels 775 and 776. Label 775 describes vertex 658 as a NOR gate having three pin vertices 660, 661 and 662. Pin vertices 661 and 662 are interchangeable since both are given the number 1. Pin vertex 660 is unique. Label 776 describes gate vertex 659 as an ANDNOR gate having four pin vertices 663, 664, 665 and 666. Pin vertices 663 and 664 are interchangeable as given by the number 1. Pin vertices 665 and 666 are unique.

Label 777 describes pin vertex 660 as a unique pin of a NOR gate attached to wire vertex 669. Label 778 describes pin vertex 661 as a pin of a NOR gate that is interchangeable with the pin vertex 662 and attached to wire vertex 668. Label 779 describes pin vertex 662 as a pin of a NOR gate that is interchangeable with the pin vertex 661 and attached to wire vertex 667.

Similarly, label 780 describes pin vertex 663 as a pin of an ANDNOR gate that is interchangeable with the pin vertex 664 and attached to wire vertex 667. Label 781 describes pin vertex 664 as a pin of an ANDNOR gate that is interchangeable with the pin vertex 663 and attached to wire vertex 668. Label 782 describes pin vertex 665 as a unique pin of an ANDNOR gate attached to wire vertex 669. Label 783 describes pin vertex 666 as a unique pin of an ANDNOR gate attached to wire vertex 670.

Label 784 describes wire vertex 667 as a wire attached to two pin vertices 662 and 663. Label 785 describes wire vertex 668 as a wire attached to two pin vertices 661 and 664. Label 786 describes wire vertex 669 as a wire attached to two pin vertices 660 and 665. Label 787 describes wire vertex 670 as a wire attached to one pin vertex 666. Labels 778 and 779 are identical as they describe interchangeable pins. The same applies for label pairs 780 and 781 and 784 and 785.

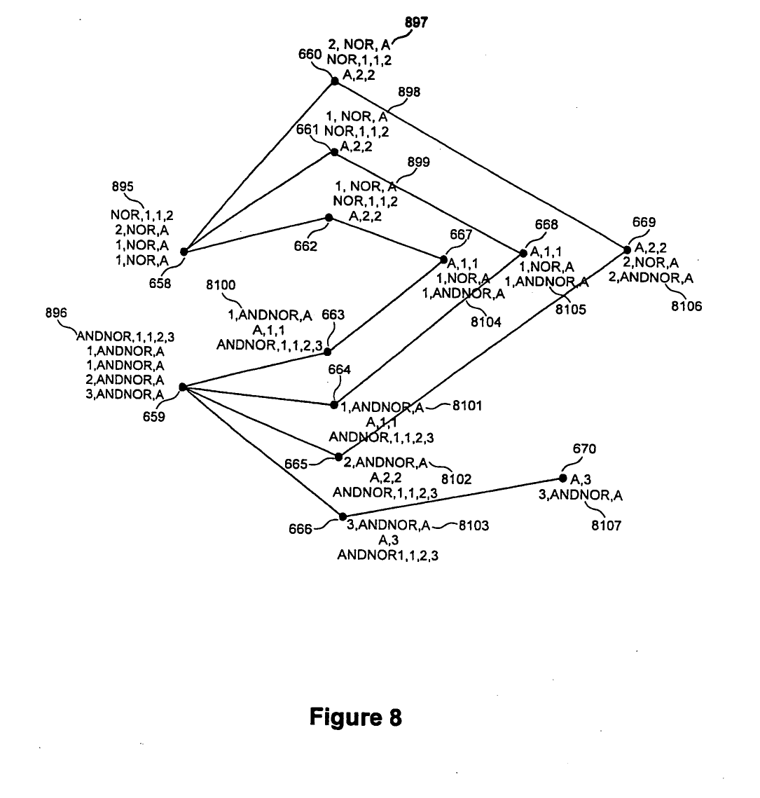

FIG. 8 shows a second level alternative hashing graph. In FIG. 8, each vertex label contains information related to its adjacent vertices from FIG. 7. Label 895 describes gate vertex 658 as a NOR gate having three pins, two interchangeable pin vertices 661 and 662 and a unique pin vertex 660. Each of these pin vertices is attached to a wire.

Label 896 describes gate vertex 659 as an ANDNOR gate having four pins, two interchangeable pin vertices 663 and 664 and two unique pin vertices 665 and 666.

Label 897 describes pin vertex 660 as a pin of a NOR gate and assigned the number 2. The label 897 further describes the NOR gate as having three pin vertices including two interchangeable pin vertices and a unique pin vertex. The label 897 also describes pin vertex 660 as being attached to wire vertex 669.

Label 898 describes pin vertex 661 as a pin of a NOR gate and assigned the number 1. The label 898 further describes the NOR gate as having three pins including two interchangeable pins and a unique pin. The label 898 also describes pin vertex 661 as being attached to wire vertex 668.

Label 899 describes pin vertex 662 as a pin of a NOR gate and assigned the number 1 as well, since it is interchangeable with pin vertex 661. The label 899 further describes the NOR gate as having three pin vertices including two interchangeable pin vertices and a unique pin vertex. The label 899 also describes pin vertex 662 as being attached to wire vertex 667.

Label 8100 describes pin vertex 663 as a pin of an ANDNOR gate and assigned the number 1. The label 8100 further describes the ANDNOR gate as having four pins including two interchangeable pin vertices and two unique pin vertices. The label 8100 also describes pin vertex 663 as being attached to wire vertex 667.

Label 8101 describes pin vertex 664 as a pin of an ANDNOR gate and assigned the number 1 as well, since it is interchangeable with pin vertex 663. The label 8101 further describes the ANDNOR gate as having four pin vertices including two interchangeable pin vertices and two unique pin vertices. The label 8101 also describes pin vertex 664 as being attached to wire vertex 668.

Label 8102 describes pin vertex 665 as a pin of an ANDNOR gate and assigned the number 2. The label 8102 further describes the ANDNOR gate as having four pins including two interchangeable pin vertices and two unique pin vertices. The label 8102 also describes pin vertex 665 as being attached to wire vertex 669.

Label 8103 describes pin vertex 666 as a pin of an ANDNOR gate and assigned the number 3. The label 8103 further describes the ANDNOR gate as having four pin vertices including two interchangeable pin vertices and two unique pin vertices. The label 8103 also describes pin vertex 666 as being attached to wire vertex 670.

Label 8104 describes wire vertex 667 as a wire attached to two pin vertices of different gates. The label 8104 further describes the wire as being attached to both a pin vertex 662 of a NOR gate assigned the number 1 and a pin vertex 663 of an ANDNOR gate also assigned the number 1.

Label 8105 describes wire vertex 668 as a wire attached to two pin vertices of different gates. The label 8105 further describes the wire as being attached to both a pin vertex 661 of a NOR gate assigned the number 1 and a pin vertex 664 of an ANDNOR gate also assigned the number 1.

Label 8106 describes wire vertex 669 as a wire attached to two pin vertices of different gates. The label 8106 further describes the wire as being attached to both a pin vertex 660 of a NOR gate assigned the number 2 and a pin vertex 665 of an ANDNOR gate also assigned the number 2.

Label 8107 describes wire vertex 670 as a wire attached to pin vertex 666 of an ANDNOR gate and assigned the number 3.

From this second level of alternative hashing, the labels 8104, 8105 and 8106 of the wire vertices 667, 668 and 669 indicate that the wires are attached to both a NOR gate and an ANDNOR gate. These labels are used to compare with other labels representing areas of extracted circuitry. This label comparison is the basis for finding repetitive sub-circuits.

The level of alternative hashing is dependent on the boundaries of the reference sub-circuit. Components adjacent to the sub-circuit, but not part of the sub-circuit, will not be included in the alternative hashing labels. In FIG. 8, for example, the labels are limited to the components of the sub-circuit. Wire vertices 667, 668 and 670 define the boundaries of this sub-circuit. By a fifth level of alternative hashing, all the gate, pin and wire vertices will have the same label.

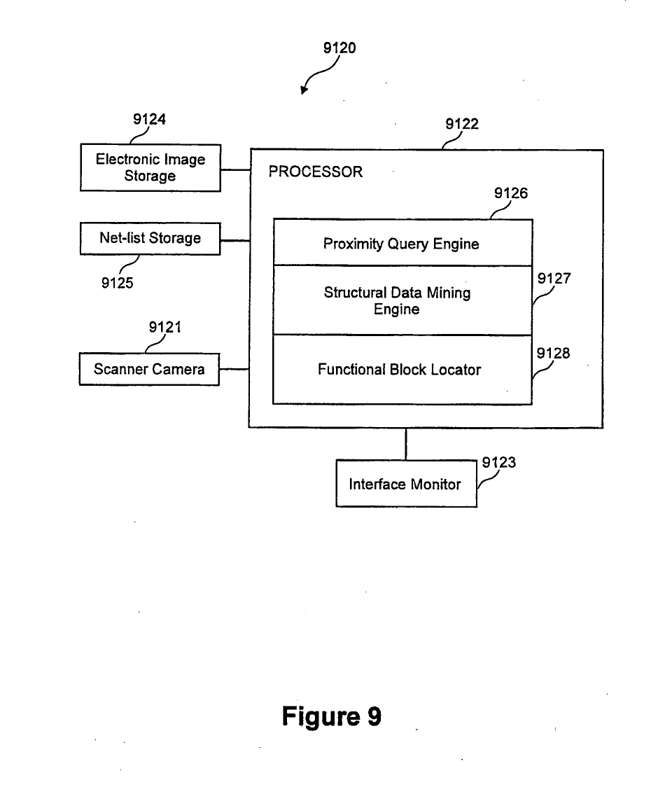

The above-described method of identifying repetitive instances of a reference circuit pattern such as a functional block, in accordance with the present invention, can also be described in conjunction with the apparatus 9120 schematically illustrated in FIG. 9.

Apparatus 9120 comprises a scanner/camera 9121, processor 9122, interface monitor 9123 and electronic image storage or memory 9124.

After the integrated circuit is de-encapsulated in a manner well known in the art to expose the top layer of the circuit in question, which is normally a metal layer, a film-based scanner 9121 scans the exposed layer under high magnification. Those having ordinary skill in this art will readily recognize that a digital camera, a scanning electron microscope (SEM) or an X-ray camera could equally be used. Preferably the scanner 9121 comprises an SEM or some such device to attain high magnification, as well as to produce an electronic image. A processor 9122 controls the scanner 9121 through interface/monitor 9123.

Memory 9124 stores a vector representation of the electronic mosaic image. Typically, the scanner 9121 only scans a portion of a layer of interconnectivity of the integrated circuit. In order to form a single electronic mosaic image of the portion of the layer, a series of overlapping images are stitched together electronically for storage in memory 9124. As well, electronic mosaic images of those layers to be analyzed are similarly aligned and registered vertically and horizontally using the vector data of the layers.

The interface monitor 9123 displays the overlaid layers in their proper sequence to form a three dimensional vector image of the IC. Each layer may be represented by a different color or cross-hatching to facilitate differentiation of layers; which in turn will more readily permit recognition of circuit elements such as transistors, gates and even more complex circuits.

Net-list storage 9125 stores the extracted electronic net-list of the circuit elements extracted using signal tracing and circuit readback.

The processor 9122 comprises a proximity query engine 9126, a structural data mining engine 9127 and a functional block locator 9128. Preferably, the proximity query engine 9126 and the structural data mining engine 9127 may be used independently during the reverse engineering process or used in conjunction with the inexact graph matching technique outlined in FIG. 4 for the functional block locator outlined in FIG. 1.

From the embodiments described above, the present invention permits time savings that would usually otherwise be required to extract repetitive patterns. The present invention overcomes the challenges that arise when extracting circuitry from a pre-existing IC rather than verifying a design layout.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A method of organizing circuitry from a net-list of an integrated circuit into a hierarchy, comprising:
a. generating a reference pattern;
b. identifying repetitive instances of said reference pattern in said net-list, using inexact graph matching;
c. creating a hierarchy within the net-list based on the identified repetitive instances; and
d. repeating a. through c. until the net-list has been organized into a hierarchy.

2. A method according to claim 1, comprising, before a., extracting the net-list.

3. A method according to claim 2, wherein the extracting comprises tracing a signal.

4. A method according to claim 2, wherein the extracting comprises reading back circuitry.

5. A method according to claim 1, wherein the generating comprises performing a proximity query.

6. A method according to claim 1, wherein the generating comprises performing structural data mining.

7. A method according to claim 1, wherein the identifying comprises accounting for errors in the net-list.

8. A method according to claim 1, wherein the identifying comprises comparing the results of confirming compliance with defined project-specific rules.

9. A method according to claim 5, wherein the performing a proximity query comprises determining the number of levels for the query.

10. A method according to claim 6, wherein the performing structural data mining comprises determining a minimum number of gates to be considered.

11. A method according to claim 1, wherein the identifying comprises applying an alternative hashing to the net-list.

12. A method according to claim 1, wherein the identifying comprises prioritizing matches in terms of quality.

13. A method according to claim 1, wherein the identifying comprises finding all instances in the net-list.

14. An apparatus adapted to organize circuitry from an existing IC layout into a hierarchy comprising:
a. a net-list data store adapted to maintain a net-list of the circuitry;
b. a pattern generator adapted to identify reference circuit patterns from the net-list;
c. a search engine adapted to find repetitive instances of the reference circuit patterns in the net-list; and
d. a hierarchy generator adapted to organize the net-list into a hierarchy based on the repetitive instances.

15. An apparatus according to claim 14, wherein the pattern generator comprises a proximity query engine.

16. An apparatus according to claim 14, wherein the pattern generator comprises a structural data miner.

17. An apparatus according to claim 14, wherein the search engine comprises an inexact graph matcher.
